(19) United States
(12) Patent Application Publication
(10) Pub. No.: US 2016/0032095 A1
(43) Pub. Date: Feb. 4, 2016

(54) PREPARATION OF RUBBER COMPOSITIONS CONTAINING SYNDIOTACTIC POLYBUTADIENE FILAMENT AND TIRES WITH COMPONENTS

(71) Applicant: The Goodyear Tire & Rubber Company, Akron, OH (US)

(72) Inventor: Paul Harry Sandstrom, Cuyahoga Falls, OH (US)

(21) Appl. No.: 14/882,495

(22) Filed: Oct. 14, 2015

Related U.S. Application Data
(62) Division of application No. 13/688,264, filed on Nov. 29, 2012.

(51) Int. Cl. C08L 47/00

(52) U.S. Cl. CPC C08L 47/00; C08L 2205/025; C08L 2205/03

(57) ABSTRACT

The invention relates to a rubber composition and tire with component of rubber composition containing filamentary syndiotactic polybutadiene.

### FIELD OF THE INVENTION

The invention relates to preparation of rubber compositions containing filamentary fibers of syndiotactic polybutadiene and tires having components containing filamentary fibers of syndiotactic polybutadiene.

### BACKGROUND OF THE INVENTION

Syndiotactic polybutadiene is a syndiotactic 1,2-polybutadiene polymer with a high syndiotactic 1,2- content prepared by polymerization of 1,3-butadiene monomer. Three possible polybutadiene structures might be formed in the polymerization of 1,3-butadiene monomer, depending on polymerization conditions. One structure is an isotactic configuration where the monomer units add to the polymer chain in the same configuration. Another structure is an atactic configuration where the disposition of monomer units in the polymer chain is random in nature. An additional structure is syndiotactic where the disposition of monomer for the polymer chain are in an alternating configuration.

Syndiotactic polybutadiene (syndiotactic 1,2-polybutadiene) is distinguished from other polybutadienes in one sense that there is participation of only one double bond in the formative polymerization. The syndiotactic 1,2-content is generally at least 80 percent and often at least 90 percent, sometimes ranging, for example, from about 82 to about 92 percent (by weight based on three types of microstructures).

Syndiotactic polybutadiene, in its uncured state, tends to be rigid, crystalline, have poor solubility characteristics and a high softening (melting) point temperature. At temperatures above its melting (softening) point it may be fluid in nature.

Conventionally tires contain various tire components that are reinforced with carbon black and precipitated silica rubber reinforcing fillers to meet various rubber properties and tire performance demands. For this invention, filamentary syndiotactic polybutadiene polymer is proposed for the elastomer reinforcement. In one aspect, it is proposed to replace a portion of rubber reinforcing carbon black and/or precipitated silica reinforcing fillers with filamentary fibers of syndiotactic polybutadiene that are dispersed in an elastomer matrix (e.g. natural or synthetic natural rubber) as a composite thereof. The unique feature of this invention is not just the use of these materials as replacements for rubber reinforcing carbon black and/or precipitated silica reinforcement in rubber compositions, but more importantly the process by which they are produced prior to addition to a conventional mixing chamber, such as a Banbury® internal rubber mixer. The melting points selected for these syndiotactic polybutadiene fibers is well above the temperatures normally used in a conventional Banbury® rubber mixer, which for this invention is limited to a maximum mixing temperature of 170° C. to mix elastomers with fillers and other compounding ingredients. For this invention, such syndiotactic polybutadiene is therefore mixed with polyisoprene rubber at high mixing temperatures above the softening point of the syndiotactic polybutadiene in order to present the syndiotactic polybutadiene as a fluid for better mixing with diene-based elastomers such as, for example at least 180° C., alternately above 200° C. or even above 220° C. in a separate mixing step to form a composite thereof, before addition of the composite to a Banbury® internal rubber mixer for conventional mixing at a lower temperature (with the maximum mixing temperature of 170° C.) with other elastomers, fillers and other compounding ingredients to create the final desired rubber component. The process used to produce these composites is uniquely chosen to create small filamentary fibers of the syndiotactic polybutadiene which will provide a reinforcement that can promote replacing a portion of rubber reinforcing carbon black and/or precipitated silica to achieve the desired cured rubber properties.

In the conception of the present invention, it was proposed that if the level of rubber reinforcing carbon black and/or precipitated silica reinforcing filler in a rubber composition could be reduced, and the omitted filler replaced with a filler material that reduced the hysteresis of the rubber composition, particularly for use as a tire tread, while maintaining a stiffness property for the rubber composition, that rolling resistance and durability of a tire having a component (e.g. tire tread) of such rubber composition could be beneficially improved, and weight reduced by using a lower gravity filler.

Historically syndiotactic polybutadiene has been suggested for an inclusion in rubber compositions for tire components, including tire treads, including adding syndiotactic polybutadiene as a masterbatch to a rubber composition. For example, and not intended to be limiting, see U.S. Pat. Nos. 5,307,850 and 6,956,093.

However, for this invention a significant departure from such historical approach is proposed.

For this invention it is envisioned that a rubber composition for a tire component be provided which contains a filamentary fiber form of syndiotactic polybutadiene, namely a rubber composition which contains syndiotactic polybutadiene filaments, particularly where the filamentary syndiotactic polybutadiene is contained as a dispersed component of an alloy thereof.

To accomplish this phenomenon it is envisioned that a filamentary form of the syndiotactic polybutadiene polymer be produced within a rubber composition as a composite thereof and that the produced syndiotactic filaments maintain their filamentary configuration, or form, while being mixed with a rubber composition under conventional high shear mixing and maximum rubber mixing temperature of 170° C. and, also, upon curing and shaping the rubber composition as a tire component in a tire mold at a maximum temperature of about 170° C.

It is to be appreciated that syndiotactic polybutadiene typically has at least 80 percent and usually at least 90 percent of its monomeric units in a syndiotactic 1,2-conguration. For this invention, it is to have a melting point of at least 180° C., and particularly at least 200° C. or even at least 230° C. It is also to be appreciated that sulfur curable rubber compositions composed of diene-based elastomers for this invention are to be mixed at preparative, non-productive (without sulfur curative), temperatures in a range of from about 140° C. to a maximum temperature of 170° C. Thereby it is appreciated that that the higher softening point syndiotactic polybutadiene crystalline polymers (below their softening points) do not mix easily with rubber compositions at the aforesaid more normal rubber mixing temperature range (maximum mixing temperature of 170° C.). For this invention, then an alloy of syndiotactic polybutadiene polymer with polyisoprene rubber is provided where the syndiotactic polybutadiene polymer is mixed at a significantly higher temperature above its softening point and above such more normal rubber mixing temperature range to form a alloy comprised of a blend of micro sized filamentary syndiotactic polybutadiene polymer and the alloy is then mixed with a rubber composition at a lower conventional rubber mixing temperature.

In order to provide a rubber composition which contains syndiotactic polybutadiene polymer in filamentary form, it is necessary that the syndiotactic polybutadiene has a melting point well above the aforesaid conventional rubber maximum mixing temperatures of 170° C. for this invention so that the filamentary form of the syndiotactic polybutadiene polymer is maintained during the rubber mixing process as well as the rubber curing process.

It is readily apparent, then, that a formative technique be used for forming and maintaining the syndiotactic polybutadiene in a filamentary form within a rubber composition for which it promotes a rubber reinforcement quality.

On this basis then, a two step process of syndiotactic polybutadiene fiber (filamentary) formation is provided.

Such two step preparation process is dependent upon a first masterbatch (or alloy) preparation at an elevated temperature using controlled high shear mixing conditions to promote the formation of syndiotactic polybutadiene micro sized domains and elongated filaments formed from the micro sized domains dispersed within a polyisoprene rubber matrix followed by allowing the masterbatch (alloy) to cool to a temperature below the softening point of the syndiotactic polybutadiene filaments and then blending the masterbatch (alloy) with a rubber composition at a significantly lower temperature than the masterbatch preparation temperature.

It is contemplated that such micro sized domains of the syndiotactic polybutadiene in said alloy are of an average size, for example, in a range of from about 0.5 to about 6 microns, It is contemplated that such syndiotactic polybutadiene filaments have an average aspect ratio (length to diameter) of, for example, up to about 10/1.

In the description of this invention, the term “phr” where used relates to parts by weight of an ingredient per 100 parts by weight of rubber, unless otherwise indicated.

The terms “rubber” and “elastomer” may be used interchangeably unless otherwise indicated. The terms “vulcanized” and “cured” may be used interchangeably unless otherwise indicated. The terms “compound” and “rubber composition” may be used interchangeably unless indicated.

The softening point of a polymer (e.g. uncured syndiotactic polybutadiene) can be determined by conventional means such as by a differential scanning calorimeter (DSC) at a heating rate of 10° C. per minute, a procedure known to those having skill in such art.

### SUMMARY AND PRACTICE OF THE INVENTION

In accordance with this invention a process of preparing a rubber composition using a two step process is comprised of blending, based on parts by weight per 100 parts by weight rubber (phr), where the terms “rubber” and “elastomer” (for the description of this invention) exclude syndiotactic polybutadiene polymer:

(A) a first step which comprises forming an alloy comprised of filamentary syndiotactic polybutadiene dispersed in a cis 1,4-polyisoprene rubber (e.g. at least one of natural and synthetic cis 1,4-polyisoprene rubber) comprised of:
(1) forming a blend of syndiotactic polybutadiene and polyisoprene rubber comprised of blending in an internal mixer:
   (a) about 2 to about 50, alternately from about 5 to about 30 parts by weight syndiotactic polybutadiene polymer having a softening point in a range of from about 180° C. to about 230° C., alternately from about 200° C. to about 230° C., alternately from about 220° C. to about 230° C., and having at least 70, alternately at least 80 and alternately at least 90, percent of its monomeric units in a syndiotactic 1,2-configuration, with
   (b) about 98 to about 50, alternately from about 95 to about 70, parts by weight of cis 1,4-polyisoprene rubber (e.g. at least one of natural and synthetic, preferably natural, cis 1,4-polyisoprene rubber);
wherein said syndiotactic polybutadiene polymer and cis 1,4-polyisoprene are blended in said internal rubber mixer rubber at a temperature of at least 10° C. above said syndiotactic polybutadiene polymer softening point (e.g. in a range of from about 190° C. to about 240° C., alternately from about 200° C. to about 240° C. and alternately from about 230° C. to about 240° C.);
(2) continuing said mixing at sufficient shear mixing conditions and mixing temperature to form a dispersion of micro sized domains of said syndiotactic polybutadiene in said cis 1,4-polyisoprene rubber and to elongate at least a portion of said domains and then cooling the composite (e.g. allowing the composite to cool while mixing or after removal from the shear mixing step) to form filamentary syndiotactic polybutadiene, followed by

(B) a second step which comprises forming a rubber composition comprised of blending up to a maximum temperature of 170° C.:
(1) 100 phr of sulfur curable diene-based elastomers comprised of said cis 1,4-polyisoprene rubber of said first step and at least one additional diene-based elastomer;
(2) sufficient quantity of said alloy to provide from about 2 to about 50, alternately from about 5 to about 30 phr of said syndiotactic polybutadiene polymer with (e.g. with 100 parts by weight of) said diene-based elastomer(s),
(3) about 0 to about 150, alternately from about 5 to about 120 phr of reinforcing filler comprised of:
   (a) precipitated silica, or
   (b) rubber reinforcing carbon black, or
   (c) combination of precipitated silica and rubber reinforcing carbon black, and

(C) wherein said process further comprises blending said rubber composition with sulfur curatives (e.g. sulfur and at least one sulfur cure accelerator) in an internal rubber mixer (e.g. at a temperature in a range of from about 110° C. to about 120° C.).

In practice, where said reinforcing filler is comprised of a combination of rubber reinforcing carbon black and precipitated silica, a silica coupler is conventionally added which contains a moiety reactive with hydroxyl groups contained on said precipitated silica and another different moiety interactive with said diene-based elastomer(s).

In further accordance with this invention a rubber composition is provided prepared by said method.

In additional accordance with this invention, a rubber composition is provided which is comprised of a blend of, based on parts by weight per 100 parts by weight rubber (phr), where the term “rubber” (for the description of this invention) excludes syndiotactic polybutadiene polymer:

(A) polymer alloy comprised of about 2 to about 50, alternately from about 5 to about 30, parts by weight of a dispersion of micro sized syndiotactic polybutadiene domains comprised primarily of filaments thereof in 98 to about 50, alternately from about 95 to about 70, parts by weight cis 1,4-polyisoprene rubber (comprised of at least one of natural and synthetic polyisoprene rubber, desirably natural cis 1,4-polyisoprene rubber) and

(B) 100 phr of sulfur curable diene-based elastomers comprised of said cis 1,4-polyisoprene rubber of said first step and at least one additional diene-based elastomer;

(C) sufficient quantity of said alloy to provide from about 2 to about 50, alternately from about 5 to about 30 phr of said filamentary syndiotactic polybutadiene, and

(D) about 0 to about 150, alternately from about 5 about 120 phr of reinforcing filler comprised of:
(1) rubber reinforcing carbon black, or
(2) combination of precipitated silica and rubber reinforcing carbon black.

In practice, where said reinforcing filler is comprised of a combination of rubber reinforcing carbon black and precipitated silica, a silica coupler is conventionally added which contains a moiety reactive with hydroxyl groups contained on said precipitated silica and another different moiety interactive with said diene-based elastomer(s).

In additional accordance with this invention a tire is provided having at least one component comprised of said rubber composition.

It can be seen that, as a first step in the process a polymer alloy is formed comprised of small syndiotactic polybutadiene domains (e.g. micro domains) which are formed in a mixing process in an internal polymer mixer together with a cis 1,4-polyisoprene rubber at an elevated temperature (e.g. at least about 180° C., alternately at least about 200° C. or even up to 240° C. and above the softening point of the syndiotactic polybutadiene having a softening point in a range of from about 180° C. to about 230° C., alternately in a range of from about 220° C. to about 230° C. The sheer force generated by the mixing process and mixing temperature is adjusted, or configured, to cause the aforesaid small domains (micro domains) of the syndiotactic polybutadiene dispersion in the polymer alloy to elongate to a filamentary form.

It can be seen that the second step of the process is comprised of blending of the polymer alloy with a rubber composition comprised of at least one sulfur curable, diene-based elastomer, and other compounding ingredients, in a conventional rubber mixer, such as for example an internal rubber mixer (e.g. Banbury® rubber mixer), rubber extruder, or open mill rubber mixer. Such second step of blending or mixing, for the practice of this invention, can be accomplished using compounding techniques well known in the art at a mixing temperature of, for example, up to a maximum of 170° C. (e.g. in a range of from about 150° C. to a maximum of 170° C.)

The aforesaid first step of the process is comprised of producing the alloy at an elevated temperature in which a micro dispersion of the filamentary syndiotactic polybutadiene polymer in the polyisoprene rubber matrix is obtained. It is to be appreciated that such high temperature mixing cannot be achieved during normal rubber mixing temperatures (the aforesaid maximum mixing temperature limitation for this invention of 170° C.) and, also that such a micro-sized dispersion of syndiotactic polybutadiene is required to be provided as said alloy at the aforesaid mixing for said alloy significantly above said normal maximum temperature for a rubber composition, therefore requiring the two-step process to achieve the rubber composition containing said alloy.

The elastomers blended in the second step of the process with the polymer alloy of said first step, which contains cis 1,4-polyisoprene rubber, are sulfur curable diene-based elastomers, thereby containing carbon-carbon unsaturation, which can be sulfur cured such as for example at least one polymer of at least one of isoprene and 1,3-butadiene and styrene and at least one of isoprene and 1,3-butadiene. Examples of such rubbers are, for example, at least one of cis-1,4-polyisoprene (natural or synthetic), cis-1,4-polybutadiene, 3,4-polyisoprene, styrene/butadiene copolymers, styrene/isoprene/butadiene terpolymers, as well as butadiene/acrylonitrile copolymers and isoprene/acrylonitrile copolymers, and mixtures thereof. Generally, it is desired that the diene-based elastomer is comprised of cis 1,4-polyisoprene or at least contains cis 1,4-polyisoprene rubber. Further, in general, a mixture of two or more elastomers comprised of, for example, at least one of natural rubber and synthetic rubbers, such as cis-1,4-polyisoprene, cis-1,4-polybutadiene, 3,4-polyisoprene, styrene/butadiene copolymers and styrene/isoprene/butadiene terpolymers may be desired.

Those skilled in the art will recognize that small amounts of additional curatives (other than sulfur), such as peroxides, can be used in the composition, if desired.

Various additives can be used and mixed with the rubber composition, such as rubber processing oils, sulfur cure accelerators and retarders, antidegradants, zinc oxide, zinc stearate fatty acids, and other pigments, as desired.

Subsequent addition of sulfur curatives (e.g. sulfur and sulfur cure accelerators) at a lower mixing temperature range are blended with the rubber composition, for example, 110° C. to 120° C. (wherein the sulfur and sulfur cure accelerators are withheld from the initial rubber mixing, as is a conventional practice).

Other such variations in the mixing of the rubber composition will be apparent to those having skill in such art.

The rubber composition of this invention containing the filamentary syndiotactic polybutadiene polymer can be used in any component of the tire, where desired, for example, to promote stiffness of a rubber composition while promoting substantial maintenance or reduction of hysteresis of the rubber composition.

While specific embodiments of the invention have been described, those skilled in the art will recognize that the invention may be variously modified and practiced without departing from the spirit of the invention. The invention is limited only by the scope of the following claims.

1. (canceled)

2. (canceled)

3. (canceled)

4. (canceled)

5. (canceled)

6. (canceled)

7. (canceled)

8. (canceled)

9. (canceled)

10. (canceled)

11. A rubber composition comprised of a blend of, based on parts by weight per 100 parts by weight rubber (phr), where the term “rubber” excludes syndiotactic polybutadiene polymer:
(A) polymer alloy comprised of about 2 to about 50 parts by weight of a dispersion of micro sized syndiotactic polybutadiene domains comprised primarily of filaments thereof in 98 to about 50 parts by weight cis 1,4-polyisoprene rubber and
(B) 100 phr of sulfur curable diene-based elastomers comprised of said cis 1,4-polyisoprene rubber of said first step and at least one additional diene-based elastomer;
(C) sufficient quantity of said alloy to provide from about 2 to about 50 phr of said filamentary syndiotactic polybutadiene, and
(D) about 0 to about 150 phr of reinforcing filler comprised of:
(1) rubber reinforcing carbon black, or
(2) combination of precipitated silica and rubber reinforcing carbon black.

12. The rubber composition 11 wherein said reinforcing filler is comprised of a combination of rubber reinforcing carbon black and precipitated silica.

13. The rubber composition of claim 11 containing a silica coupler is contains a moiety reactive with hydroxyl groups contained on said precipitated silica and another different moiety interactive with said diene-based elastomer(s).

14. The rubber composition of claim 11 wherein said additional diene-based elastomer is comprised of at least one of polymer(s) of at least one of isoprene and 1,3-butadiene and styrene with at least one of isoprene and 1,3-butadiene.

15. The rubber composition of claim 11 wherein said syndiotactic polybutadiene has a softening point in a range of from about 220° C. to about 230° C. and having at least 90 percent of its monomeric units in a syndiotactic 1,2-configuration.

16. A tire having at least one component comprised of the rubber composition of claim 11.

17. A tire having at least one component comprised of the rubber composition of claim 12.

18. A tire having at least one component comprised of the rubber composition of claim 13.

19. A tire having at least one component comprised of the rubber composition of claim 14.

20. A tire having at least one component comprised of the rubber composition of claim 15.
